(19) United States
(12) Patent Application Publication
(10) Pub. No.: US 2024/0345981 A1
(43) Pub. Date: Oct. 17, 2024

(54) DUAL CONNECTION PERIPHERAL DEVICE WITH CAPTIVE CABLE AND AUXILIARY PORT

(71) Applicant: Other World Computing, Woodstock, IL (US)

(72) Inventors: Tal E. Volk, Portland, OR (US); Farshid Tabrizi, San Jose, CA (US)

(21) Appl. No.: 18/624,296

(22) Filed: Apr. 2, 2024

Related U.S. Application Data
(60) Provisional application No. 63/458,707, filed on Apr. 12, 2023.

(51) Int. Cl. G06F 13/40; G06F 13/12

(52) U.S. Cl. CPC G06F 13/4081; G06F 13/124; G06F 2213/3854

(57) ABSTRACT

A dual connection peripheral device has a housing. A captive input/output cable is disposed at least partially within the housing and selectively connects the dual connection peripheral device to a host device. An auxiliary input/output port is disposed on the housing and selectively connects to the host. A control circuit is operatively coupled to the captive input/output cable and auxiliary input/output port and selectively connects one of the captive input/output cable and the auxiliary input/output port to the host device.

### CROSS REFERENCE TO RELATED APPLICATIONS

This application claims the benefit of U.S. Provisional Application No. 63/458,707 filed on Apr. 12, 2023. The entire contents of this application is incorporated herein by reference in its entirety.

### BACKGROUND OF THE INVENTION

The present invention is directed to a peripheral device for a computer, and more particularly, a peripheral device capable of selectively providing a connection to a host computer from each of an input/output captive cable and input/output port.

As is known in the art, peripheral devices, such as memory card readers, are commonly used with computers to enhance their functionality and expand their input/output capabilities. However, the process of connecting a peripheral device to a computer can be cumbersome, requiring either a captive cable that may be too short for certain circumstances or a dedicated uplink port that requires a separate cable to be carried around. Users may find this inconvenience frustrating, especially if neither the captive cable nor the dedicated uplink port solutions match their specific needs.

Accordingly, a peripheral device which overcomes the shortcomings of the prior art is desired.

### SUMMARY OF THE INVENTION

A dual connection peripheral device has a housing. A captive input/output cable is disposed at least partially within the housing and selectively connects the dual connection peripheral device to a host device. An auxiliary input/output port is disposed on the housing and selectively connects to the host. A control circuit is operatively coupled to the captive input/output cable and auxiliary input/output port and selectively connects one of the captive input/output cable and the auxiliary input/output port to the host device.

In a preferred embodiment the control circuit detects which one of the captive input/output cable and the auxiliary input/output port is currently coupled to peripheral device and selects an output as a function thereof.

In another embodiment of the invention the peripheral device includes a power source.

### BRIEF DESCRIPTION OF THE DRAWINGS

The present disclosure will be better understood by reading the written description with reference to the accompanying drawing figures in which like reference numerals denote similar structure and refer to like elements throughout in which:

FIG. 1 is a block diagram of a peripheral device constructed in accordance with the invention; and

FIG. 2 is a flowchart for operation of the peripheral device in accordance with the invention.

### DETAILED DESCRIPTION OF THE PREFERRED EMBODIMENTS

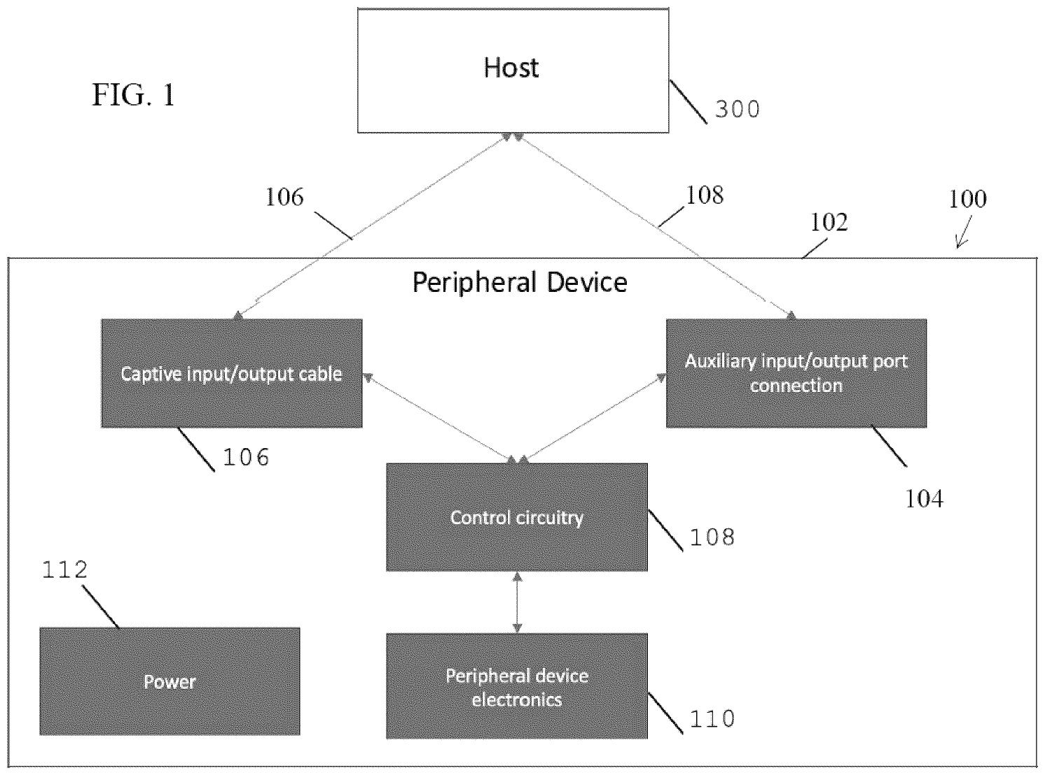

Reference is first made to FIG. 1, in which a dual connection peripheral device generally indicated as 100, constructed in accordance with the invention is provided. Dual connection peripheral device 100 has a physical housing 102. Housing 102 may be constructed from various materials such as plastics, metals, or a combination thereof. The size and weight of housing 102 may vary depending on the specific design and intended use of the device as will be seen below.

A captive input/output cable 106 is disposed in the housing 102 and extends at least partially without the housing 102 to operatively communicate with a host device, such as a computer, 300. In this way, captive input/output cable 106 is integrated into body 102. Captive input/output cable 106 is preferably short enough to either stow within housing 102 or protrude from housing 102 a minimal amount. A short captive input/output cable 106 has the benefit of reducing the clutter and unwanted excess cable length. Captive input/output cable 106 is permanently affixed to housing 102 so that it cannot be easily separated or lost.

An auxiliary input/output port connection 104 is also disposed in housing 102 and oriented so as to connect with host computer 300 by a connection cable 108 coupled at input/output port connection 104. The auxiliary input/output port 104 may be implemented as any appropriate type of input/output port, including but not limited to USB Type-C, USB Type-A, HDMI, Ethernet, wireless, or any other suitable port type, depending on the specific needs and preferences of the target user group. In a preferred non limiting embodiment, auxiliary input/output port connection 104 and captive input/output cable 106 are of the same type of connector such as those listed above.

It is important that only one connection to a given host can be used at one time to ensure that there is no interference or conflict between the two connections. If both the captive input/output cable 106 and the auxiliary input/output port 104 were allowed to be connected to the same host 300 at the same time, it could cause issues with data transmission and could potentially damage the peripheral device, host, or the data itself. Limiting the use of only one connection at a time also simplifies the user experience, reducing the potential for confusion and minimizing the need for manual switching or configuration.

Therefore, peripheral device 100 includes a control circuitry 108, disposed in housing 102. The control circuitry 108 receives an input from peripheral device electronics 110, such as an audio input, card reader input, a USB, an RFID input, or the like, by way of non-limiting example, and operatively communicates with each of captive input/output cable 106 and the auxiliary input/output port 104. Control circuitry 108 controls an output 110 of peripheral device 100, determining which of inputs input/output captive input/output cable 106 and the auxiliary input/output port 104 is to be operatively connected to host 110 to receive the data from peripheral device electronics 110. Control circuitry 108 determines which of captive cable input/output 106 and the auxiliary input/output port 104 is in use and disables/ignores the other for data transmission. In one non limiting preferred embodiment, control circuitry 108, detects the existence of power and/or data at either of captive cable input/output 106 and the auxiliary input/output port 104 as an indicator of use and allowing data from whichever of the two has power and/or data as the gating function. It should be noted that it is well within the scope of the invention to use physical switches for permitting connectivity of a respective connection as well. Additionally, one of input/output captive input/output cable 106 and the auxiliary input/output port 104 may be designated or preconfigured as the default switched input until a connection occurs at the other input.

The peripheral device 100 may be powered through the computer (host) 300, or in a preferred non limiting embodiment, peripheral device 100 may have its own power source 112, such as a battery or external power supply. The power source 112 may be integrated into the housing 102 of the device or may be a separate component.

The peripheral device, in accordance with the invention, may include additional features, such as status indicators, switches, or buttons, to enhance its functionality and user experience. For example, it may include status indicators to show when the device is connected to a host or when it is transmitting data. In some embodiments, as will be described below, the peripheral device is designed to default to one of the two input/output connections, without the need for a manual switch or other user interface component. For example, the device 100 may be designed to automatically use the captive input/output captive cable 106 when it is connected to a host machine, and to subsequently switch to the auxiliary input/output port 104 only when a compatible peripheral device is detected on that port.

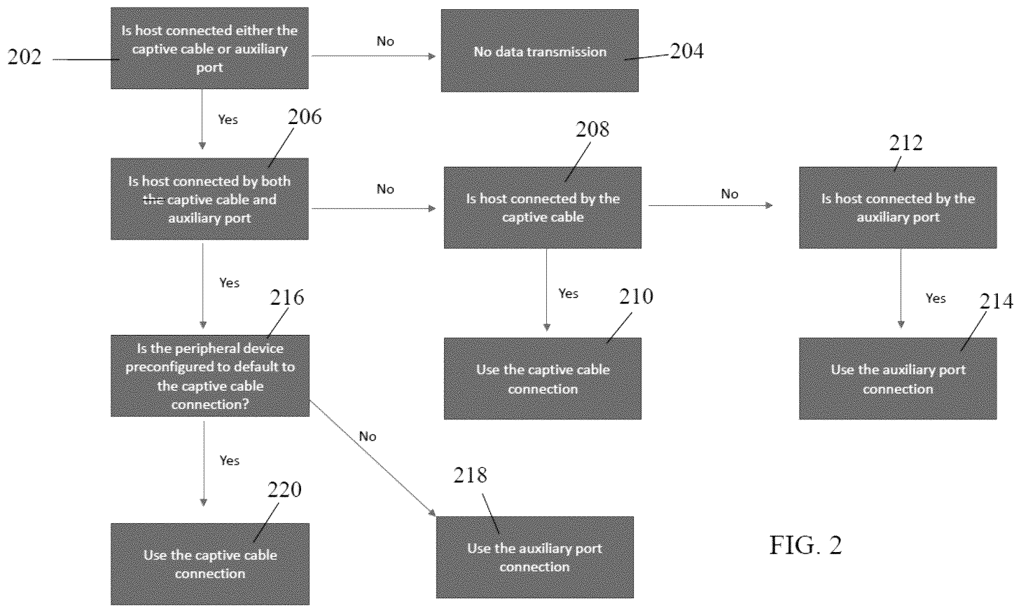

Reference is now made to FIG. 2 in which the operation of peripheral device 100 is provided. In a first step 202 it is determined whether host 300 is connected to either of input/output captive cable 106 or the auxiliary input/output port 104. If host 300 is not connected to either of input/output captive cable 106 and the auxiliary input/output port 104 then there will be no data transmission in a step 204 and the process is returned to step 202.

If it is determined in step 202 that host 300 is connected to at least one of input/output captive cable 106 and the auxiliary input/output port 104, then in a step 206 it is determined whether host 300 is connected by both captive input/output cable 106 and the auxiliary input/output port 104. If the answer is yes, then in a step 210 captive input/output cable connection 106 is used.

If it is determined in a step 208 that the host is not connected to captive cable 106, then in a step 212 it is determined whether host 300 is connected to the auxiliary input/output port 104. If yes, then in a step 214 the auxiliary input/output port 104 is used to connect the peripheral device 100 to host 300.

If in step 206 it is determined that host 300 is connected by captive input/output cable 106 and the auxiliary input/output port 104, then is a step 216 it is determined whether the peripheral device 100 is to default to captive input/output cable 106 or to the auxiliary input/output port 104 as discussed above. If it is determined in step 216 that captive input/output cable 106 is in use, as discussed above, then in a step 220 the device and any data input at captive input/output cable 106 will be operatively coupled/output to host 300. If it is determined in step 216 that input/output port 104 is the connection in use, as discussed above, then in a step 218 the device and any data input at input/output port 104 will be operatively coupled/output to host 300.

As can be seen from the above, the present invention is a peripheral device that allows for both a captive input/output cable and an auxiliary input/output port to be used in a single device. This dual-connection feature provides users with the convenience of a captive cable and the flexibility of a dedicated uplink port, allowing them to choose the best option for their specific needs.

The present invention solves the problems of the prior art by adding both a captive input/output (I/O) cable and an auxiliary I/O port in a single peripheral device. This innovative dual connection provides users with the convenience of a captive cable and the flexibility of a dedicated uplink port, allowing them to choose the best option for their specific needs. By simplifying the process of connecting and using peripheral devices, a single peripheral device can meet the needs of a larger user group.

As can be seen the invention has numerous potential applications in a variety of settings, including but not limited to home offices, professional workspaces, and educational environments. Its advantages include increased convenience, improved organization, and enhanced functionality. As consumers increasingly demand streamlined and efficient technology solutions, the present invention is poised to meet this growing need.

It will thus be seen that the objects set forth above, among those made apparent from the preceding description, are efficiently attained and, since certain changes may be made in carrying out the above method and in the construction set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

1. A dual connection peripheral device for communicating with a host device comprises:
a housing;
a captive input/output cable disposed at least partially within the housing and configured to be selectively connected to the host;
an auxiliary input/output port disposed on the housing and configured to be selectively connected to the host; and
a control circuitry operatively coupled to the captive input/output cable and auxiliary input/output port and selectively connects one of the captive input/output cable and the auxiliary input/output port to the host device as a function of a condition detected at least one of the captive input/output cable and auxiliary input/output port.

2. The peripheral device of claim 1, wherein the captive input/output cable is permanently affixed to the peripheral device.

3. The peripheral device of claim 1, wherein the auxiliary input/output port is of a type selected from a group consisting of any suitable standard or non-standard port type.

4. The peripheral device of claim 1, further comprising a power source for powering the peripheral device.

5. The peripheral device of claim 4, wherein the power source is disposed in the housing of the peripheral device.

6. The peripheral device of claim 4, wherein the power source disposed outside of the housing, but operatively coupled to the switch.

7. The peripheral device of claim 4, wherein the power source is the host machine.

8. The peripheral device of claim 1, wherein the control circuitry is pre-configured to automatically use the captive input/output cable when the peripheral device is connected to the host machine, and to switch to the auxiliary input/output port only when a compatible peripheral device is detected on that port.

9. The peripheral device of claim 1, wherein the control circuitry is pre-configured to automatically use the auxiliary input/output port when the peripheral device is connected to the host machine, and to switch to the captive input/output cable only when a compatible peripheral device is detected connected to that cable.

10. The peripheral device of claim 1, wherein the peripheral device is configured to connect to the host device using only one of the captive input/output cable or the auxiliary input/output port at a time for data transmission.
